(19) United States
(12) Patent Application Publication
(10) Pub. No.: US 2026/0279226 A1
(43) Pub. Date: Sep. 17, 2026

(54) ALVEOLAR BONE GRAFT (ABG) SIMULATOR AND METHOD OF USE THEREOF

(71) Applicant: THE HOSPITAL FOR SICK CHILDREN, Toronto, Ontario (CA)

(72) Inventors: Jerry SHEN, Milton, Ontario (CA); David M. FISHER, Toronto, Ontario (CA); Dale J. PODOLSKY, Toronto, Ontario (CA)

(21) Appl. No.: 19/470,122

(22) PCT Filed: Mar. 29, 2024
(86) PCT No.: PCT/CA2024/050415

§ 371 Date: Sep. 29, 2025

Related U.S. Application Data
(60) Provisional application No. 63/455,354, filed on Mar. 29, 2023.

(51) Int. Cl. G09B 23/34

(52) U.S. Cl. CPC G09B 23/34

(57) ABSTRACT

A simulator for practicing alveolar bone graft (ABG) surgery, comprising: a cartridge configured to incorporate an oral cavity having a cleft of the alveolus formed therein; a model that resembles a human face wherein to which cartridge can removably attached, and a base configured to removably attach to the model. Such simulator being configured specifically to reflect the physical elements of an oral cleft that can be corrected by an ABG and comprising elements that are formed from materials that are similar in characteristics to the corresponding elements of such a human cleft. Elements are formed individually and connected in manner that forms: layers of elements; and positioning of and interactions between elements to assist with training of ABG surgical skills. Surgical procedures for ABG may be performed upon the simulator utilizing the same surgical tools and steps, and having the same feel, as performing surgery upon a human subject.

This application claims the benefit of U.S. Provisional Patent Application Ser. No. 63/455,354 filed Mar. 29, 2023.

### FIELD OF INVENTION

This invention relates in general to the field of surgical simulation tools and methods for making and using same, and more particularly to surgical simulation tools for procedures involving an alveolar bone graft (ABG).

### BACKGROUND OF THE INVENTION

It is known in the art of surgical education and training to employ physical simulators to allow surgeons and students to practice techniques involved in successful surgical outcomes, not only to enhance subsequent operating room performance but also to enable improved competency-based surgical student assessment.

Surgical simulators are particularly important for training in regards to technically challenging surgical procedures. Alveolar bone graft surgery is required to repair the cleft of the alveolus, and the procedure is technically challenging to perform as it requires careful soft tissue dissection to create a water tight enclosure to encase harvested bone graft. The procedure is required to close the cleft of the alveolus to allow movement of the teeth to appropriately form the upper arch of the maxilla. In addition, closure of the alveolar cleft closes the communication between the mouth and the nose. The procedure requires an understanding of the three-dimensional shape of the cleft as well as the numerous soft tissue mucosal flaps that need to be created to close the cleft. These factors cause the alveolar bone graft procedure to be challenging to conceptualize. Simulators are therefore critical to provide a means for a surgeon to practice this procedure.

Prior art physical simulator models are commonly overly-simplistic and suffer from a lack of useful reflection of actual anatomical details that would be encountered during surgical procedures conducted on patients, resulting in reliance on computer model and cadaver-based training. Computer models have obvious limitations as surgical training tools, and cadavers with the requisite physical conditions may be difficult to obtain.

This deficiency in the availability of useful physical simulator models is evident in the context of alveolar bone graft (ABG) procedures.

U.S. Patent Application Publication No. 2014/0057236 owned by Simquest International LLC and filed on Aug. 21, 2013 (Simquest), describes a physical surrogate surgical interface that represents an interface between a user and a simulated patient in a simulated surgical scenario that involves manipulation of both simulated hard and soft tissue. More specifically, the disclosed invention involves the surgical simulation generator rendering the real time simulation state data into a real time computer graphics generated video representation of the surgical simulation and providing the real time video representation to a display for real time viewing by the user. As the user utilizes the simulator, sensor(s) sense the user's manipulation of the surrogate surgical interface. The simulator generator generates a real time 3D surgical simulation of the surgical scenario based on the manipulation sensed by the sensor. Thus, the simulator disclosed involves computer generated video representation components to function.

Other prior art focuses on surgical simulators for specific types of procedures, such as the Endoscopic Endonasal Skull Base Surgery Trainer disclosed in PCT application publication WO/2023/170598 filed by All India Institute of Medical Sciences on Sep. 14, 2023; and the Advanced Training System Mannequin Simulator With Alveolar bone graft disclosed in U.S. Patent Application Publication No. 2023/0368701 filed by Teresa de Jesus Pannaci Padron on Mar. 18, 2023.

While some initial efforts have been made in the field to create more useful, detailed physical models for practice and training, a deficiency exists in the specific context of alveolar bone graft (ABG) surgical procedures. What is needed is a simulator for alveolar bone graft (ABG) surgical procedures that: reflects the anatomical complexity involved in such biological conditions; is specifically configured as a simulator tool specific to such biological condition; wherein the elements have an interaction and layering that reflects the condition and creates a simulated interaction, layering and feel similar to that of the condition and as encountered in surgical processes performed relating to such condition, such as an embodiment that is devoid of solid mandible components; and wherein the surgical simulator comprises a model of a human face wherein a cartridge configured as an oral cavity that incorporates a cleft of the alveolus can be removably attached, and said model is removably attachable to a base. What is further needed is a surgical simulator that allows performance of an alveolar bone graft surgical procedures in a realistic simulated environment to thereby allow trainees to practice the procedure to gain experience prior to operating on human patients.

### SUMMARY OF THE INVENTION

In one aspect, the present disclosure relates to an alveolar bone graft surgery simulator comprising: a cartridge configured to incorporate an oral cavity having a cleft of the alveolus formed therein; a model that resembles a human face to which the cartridge is removably attachable, and a base configured to removably attach to the model and to the cartridge.

In another aspect, the present disclosure relates to the alveolar bone graft surgery simulator, wherein the cartridge incorporates bone components and soft tissue components configured to form a maxilla having a gap in the alveolus.

In another aspect, the present disclosure relates to the alveolar bone graft surgery simulator, wherein the connection between the model and the base is operable to: hold the model at an orientation that is the orientation of a face during an alveolar bone graft surgical procedure; and to stabilize the model during a simulation alveolar bone graft surgery performed upon the alveolar bone graft surgery simulator.

In another aspect, the present disclosure relates to the alveolar bone graft surgery simulator, wherein the model is devoid of solid mandible components.

In another aspect, the present disclosure relates to the alveolar bone graft surgery simulator, wherein a retraction assistance device is removably attached to the base, and functions to provide retraction of elements of the cartridge and model during use of the alveolar bone graft surgery simulator.

In another aspect, the present disclosure relates to the alveolar bone graft surgery simulator, wherein a clamp is removably attached to the base and said clamp is operable to hold the alveolar bone graft simulator in a stable and stationary position.

In another aspect, the present disclosure relates to a method of forming an alveolar bone graft surgery simulator consisting of: forming a cartridge by layering simulated physiological tissues upon a simulated maxilla bone to form a cleft of the alveolus, said maxilla bone having a base connector component formed therein; forming a face component that simulates human facial skin, and incorporates face connector elements in a rear side of said face component; attaching the face component to the cartridge to produce a simulated human head or portion thereof having a cleft of the alveolus formed therein; and attaching the combined cartridge and face component to a base through connection of the face connector elements to corresponding base pins, connection of the base connector in the maxilla bone to corresponding slots in the base.

In another aspect, the present disclosure relates to a method of performing alveolar bone graft surgery upon an alveolar bone graft surgery simulator consisting of: assembling the alveolar bone graft surgery simulator by connecting a cartridge configured to incorporate an oral cavity having a cleft of the alveolus formed therein to a base configured to removably attach to the model; and performing an alveolar bone graft surgical procedure upon the alveolar bone graft surgery simulator.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

The invention will be better understood and objects of the invention will become apparent when consideration is given to the following detailed description thereof. Such description makes reference to the annexed drawings wherein:

FIG. 1 is a front perspective view of a base component of an embodiment of the present invention.

FIG. 2 is a side perspective view of a maxilla component of an embodiment of the present invention showing extensions for securing the maxilla.

FIG. 3 is a top perspective view of a maxilla component of an embodiment of the present invention showing extrusions for attaching teeth thereto.

FIG. 4 is a lower perspective view of a maxilla component of an embodiment of the present invention showing a palate defect formed therein.

FIG. 5 is a rear perspective view of a maxilla component of an embodiment of the present invention.

FIG. 6 is a front perspective of a maxilla component of an embodiment of the present invention having mesh attached thereto.

FIG. 7 is a front view of a face layer of an embodiment of the present invention.

FIG. 8 is a rear view of a face layer of an embodiment of the present invention.

FIG. 9 is a front view of a upper face mold component of the mold for casing the face component of an embodiment of the present invention.

FIG. 10 is a rear view of an upper face mold component of the mold for casting the face component of an embodiment of the present invention showing sockets formed therein

FIG. 11 is a mold base of the mold for casting the face component of an embodiment of the present invention showing extrusions formed thereupon.

FIG. 12 is a lower face mold component of the mold for casting the face component of an embodiment of the present invention showing the sockets formed therein.

FIG. 13 is an assembled mold for casting the face component of an embodiment of the present invention.

FIG. 14 is a front view of a molded face layer of an embodiment of the present invention.

FIG. 15 is a rear view of a molded face layer of an embodiment of the present invention.

FIG. 16 is a lower view of teeth components of an embodiment of the present invention.

FIG. 17 is a top view of teeth components of an embodiment of the present invention.

FIG. 18 is a perspective view of teeth components of an embodiment of the present invention showing sockets formed therein.

FIG. 19 is a perspective view of a maxilla component of an embodiment of the present invention mounted onto a rod for rotating the maxilla.

FIG. 20 is a side perspective view of a maxilla component of an embodiment of the present invention showing a coating of shellac applied thereto.

FIG. 21 is a top perspective view of a maxilla component of an embodiment of the present invention showing a coating of shellac applied thereto.

FIG. 22 is a lower perspective view of a maxilla component of an embodiment of the present invention showing a coating of shellac applied thereto.

FIG. 23 is a rear perspective view of a maxilla component of an embodiment of the present invention showing a coating of shellac applied thereto.

FIG. 24 is a side perspective view of a maxilla component of an embodiment of the present invention showing a coating of silicone applied thereto.

FIG. 25 is a top perspective view of a maxilla component of an embodiment of the present invention showing a coating of silicone applied thereto.

FIG. 26 is a lower perspective view of a maxilla component of an embodiment of the present invention showing a coating of silicone applied thereto.

FIG. 27 is a rear perspective view of a maxilla component of an embodiment of the present invention showing a coating of silicone applied thereto.

FIG. 28 is a side perspective view of a maxilla component of an embodiment of the present invention showing a mesh piece attached thereto which is coated with silicone.

FIG. 29 is a top perspective view of a maxilla component of an embodiment of the present invention showing a mesh piece attached thereto which is coated with silicone.

FIG. 30 is a lower perspective view of a maxilla component of an embodiment of the present invention showing a mesh piece attached thereto which is coated with silicone.

FIG. 31 is a rear perspective view of a maxilla component of an embodiment of the present invention showing a mesh piece attached thereto which is coated with silicone.

FIG. 32 is a side perspective view of a maxilla component of an embodiment of the present invention showing a first mucosa layer coating applied thereto.

FIG. 33 is a top perspective view of a maxilla component of an embodiment of the present invention showing a first mucosa layer coating applied thereto.

FIG. 34 is a lower perspective view of a maxilla component of an embodiment of the present invention showing a first mucosa layer coating applied thereto.

FIG. 35 is a rear perspective view of a maxilla component of an embodiment of the present invention showing a first mucosa layer coating applied thereto.

FIG. 36 is a side perspective view of a maxilla component of an embodiment of the present invention showing multiple fat layers coatings applied thereto.

FIG. 37 is a top perspective view of a maxilla component of an embodiment of the present invention showing multiple fat layers coatings applied thereto.

FIG. 38 is a lower perspective view of a maxilla component of an embodiment of the present invention showing multiple fat layers coatings applied thereto.

FIG. 39 is a rear perspective view of a maxilla component of an embodiment of the present invention showing multiple fat layers coatings applied thereto.

FIG. 40 is a rear view of the face layer component of an embodiment of the present invention showing an adhesive applied thereto.

FIG. 41 is a top perspective view of a maxilla component of an embodiment of the present invention showing adhesive applied thereto.

FIG. 42 is a side view of a face layer component attached to a maxilla of an embodiment of the present invention.

FIG. 43 is a front view of a face layer component attached to a maxilla of an embodiment of the present invention.

FIG. 44 is a lower view of a face layer component attached to a maxilla of an embodiment of the present invention.

FIG. 45 is a top view of a face layer component attached to a maxilla of an embodiment of the present invention.

FIG. 46 is a rear view of a face layer component attached to a maxilla of an embodiment of the present invention.

FIG. 47 is an exposed palate rear view of a face layer component attached to a maxilla of an embodiment of the present invention.

FIG. 48 is a rear view of a face layer component attached to a maxilla of an embodiment of the present invention showing second and third layers of mucosa applied thereto.

FIG. 49 is an exposed palate rear view of a face layer component attached to a maxilla of an embodiment of the present invention showing second and third layers of mucosa applied thereto.

FIG. 50 is an exposed palate lower view of a face layer component attached to a maxilla of an embodiment of the present invention showing teeth attached thereto.

FIG. 51 is an exposed palate lower perspective view of a face layer component attached to a maxilla of an embodiment of the present invention showing teeth attached thereto.

FIG. 52 is an exposed palate side perspective view of a face layer component attached to a maxilla of an embodiment of the present invention showing teeth attached thereto.

FIG. 53 is an exposed palate side perspective view of a face layer component attached to a maxilla of an embodiment of the present invention showing teeth attached thereto.

FIG. 54 is a top perspective view of a surgical simulator base component of an embodiment of the present invention.

FIG. 55 is a top perspective view of a stabilizing plate component of an embodiment of the present invention.

FIG. 56 is a top perspective view of a surgical simulator holder of an embodiment of the present invention formed of a stabilizing plate component attached to a surgical simulator base component.

FIG. 57 is top view of a surgical simulator holder of an embodiment of the present invention showing sockets formed therein.

FIG. 58 is a front perspective view of a surgical simulator holder of an embodiment of the present invention showing extrusions formed therein.

FIG. 59 is a side perspective view of a surgical simulator holder of an embodiment of the present invention showing depressions formed therein.

FIG. 60 is a side perspective view of a pin of an embodiment of the present invention.

FIG. 61 is a front view of a clamp of an embodiment of the present invention.

FIG. 62 is a side view of a clamp of an embodiment of the present invention.

FIG. 63 is a is a front view of a clamp attacher component of an embodiment of the present invention showing extrusion formed therein.

FIG. 64 is a threaded screw of an embodiment of the present invention.

FIG. 65 is a clamp body of an embodiment of the present invention.

FIG. 66 is a clamp pressure cover of an embodiment of the present invention.

FIG. 67 is an arm lower arm component of an embodiment of the present invention.

FIG. 68 is an arm ball mount connector component of an embodiment of the present invention.

FIG. 69 is an arm base component of an embodiment of the present invention.

FIG. 70 is a lower arm ball mount connector component of an embodiment of the present invention.

FIG. 71 are upper arm components of an embodiment of the present invention.

FIGS. 72 and 73 are assembled retraction arms of an embodiment of the present invention.

FIG. 74 is an assembled retraction assistance device of an embodiment of the present invention.

FIG. 75 is an exploded view of the surgical simulator of an embodiment of the present invention.

FIG. 76 is a lower front view of the surgical simulator of the present invention showing the assembled face component positioned to be attached to the surgical simulator holder.

FIG. 77 is a lower front view of the assembled surgical simulator of the present invention.

FIG. 78 is a side view of the surgical simulator of the present invention showing the assembled face component positioned to be attached to the surgical simulator holder.

FIG. 79 is a side view of the assembled surgical simulator of the present invention showing the securing pin attaching the components of the surgical simulator.

FIG. 80 is an exploded view of the surgical simulator of an embodiment of the present invention showing the alignment of depressions formed in the face component with extrusions formed in the surgical simulator holder.

FIGS. 81-83 are lower front views of the assembled surgical simulator of an embodiment of the present invention showing the face component resting upon pegs and varying positions of the connection between the depressions in the face component and the pegs.

FIG. 84 is a bottom view of the surgical simulator of an embodiment of the present invention showing adhesion pieces attached thereto.

FIG. 85 is a top view of an assembled surgical simulator having a clamp attached thereto of an embodiment of the present invention.

FIG. 86 is a lower front view of an assembled surgical simulator having a clamp attached thereto of an embodiment of the present invention.

FIGS. 87 and 88 are top views of a retraction assistance device engaged to retract a portion of the face component of the surgical simulator of an embodiment of the present invention.

FIG. 89 is a lower front view of a surgical simulator positioned for use for an alveolar bone graft (ABG) procedure.

FIG. 90 is a rear view of a surgical simulator positioned for use for an alveolar bone graft (ABG) procedure.

FIGS. 91-118 are upper views of a surgical simulator having an alveolar bone graft (ABG) procedure performed thereupon of an embodiment of the present invention.

In the drawings, embodiments of the invention are illustrated by way of example. It is to be expressly understood that the description and drawings are only for the purpose of illustration and as an aid to understanding, and are not intended as a definition of the limits of the invention.

### DETAILED DESCRIPTION OF THE PREFERRED EMBODIMENT

A simulator for practicing alveolar bone graft (ABG) surgery, comprising: a cartridge configured to incorporate an oral cavity having a cleft of the alveolus formed therein; a model that resembles a human face wherein to which cartridge can removably attached, and a base configured to removably attach to the model. Such simulator is configured specifically to reflect the physical elements of an oral cleft that can be corrected by an ABG and comprising elements that are formed from materials that are similar in characteristics to the corresponding elements of such a human cleft. Elements are formed individually and connected in manner that forms: layers of elements; and positioning of and interactions between elements to assist with training of ABG surgical skills. Surgical procedures for ABG may be performed upon the simulator utilizing the same surgical tools and steps, and having the same feel, as performing surgery upon a human subject.

The present invention is a simulator for practicing alveolar bone graft surgery, comprising: a simulated premaxilla bone; and a simulated prolabium tissue separably attached to the simulated premaxilla bone. Such simulator is configured to comprise elements in an assembly that is similar in characteristics to the corresponding elements of an oral cleft upon which an ABG surgical procedure may be performed. The configuration of the surgical simulator promotes learning and skills training relating to oral cleft and its correction by an ABG surgical procedure. Surgical procedures that can be performed upon a human oral cleft may be performed upon the simulator. The similarities in look and feel to a human oral cleft enhances the learning of surgical skills by the users of the simulator invention.

Throughout the following description, specific details are set forth in order to provide a more thorough understanding of the invention, in particular for persons skilled in the art. Notably, well known elements, that would be known to persons skilled in the art, may not have been shown or described in detail to avoid unnecessarily obscuring the disclosure. The following description of examples of the invention is not intended to be exhaustive or to limit the invention to the precise form of any exemplary embodiment. Accordingly, the description and drawings are to be regarded in an illustrative, rather than a restrictive, sense.

The present invention is directed to a simulator for practicing alveolar bone graft surgery, comprising a cartridge that incorporates simulated human elements existing in an oral cleft, including a maxilla bone. The present invention further incorporates simulated tissue separably attached to the simulated maxilla bone. A simulated orosnasal fistula is formed in the maxilla bone to simulate an oral cleft in the maxilla bone. Layers of simulated periosteal layers, mucosal layers and fat layers are attached to the maxilla bone. The maxilla portion forms the cartridge component of the invention.

The simulator of the present invention further comprises a multilayer simulated facial skin comprising the lower portion of a human face extending from the nasal skin to the chin of a human face, and incorporating a full lips portion that is openable and retractable in the manner of the lips of a human mouth area.

All references to elements of an oral cleft herein are references to simulated elements, created in accordance with the present invention, as described herein. The word “simulated” does not appear before references to all such elements, but should be read into each reference of such elements, as all elements of the simulator are simulated elements.

There are several processes that can be applied to forming the elements of the present invention. Some of these processes are described herein. Each element is created individually, and then assembled with the other elements to form the simulator, as described herein.

Generally, the elements are added to the assembly of the simulator individually in accordance with steps that result in some elements being positioned in a layered manner (whereby elements are positioned above or below other elements). The connections between the elements are further formed in a manner to create interactions between the elements, for example movement in relation to other elements, processes required for detaching elements one from another. The present invention may be anatomically accurate, or close thereto, when compared to a human oral cleft and the portions of a human head that will be accessed during an alveolar bone graft surgical procedure. However, the simulator is further created to reflect connections, positioning of elements and interactions between elements that are similar to an oral cleft and the portions of a human head that will be accessed during an alveolar bone graft surgical procedure.

Moreover, as the elements of the simulator are created individually and assembled by positioning and connecting the elements, the positions and connections of such elements can be modified in versions of the simulator. Such variations will further affect the interactions of the elements with each other, and the experience of a user who performs a surgical procedure or other learning upon the simulator. A skilled reader will recognize that these characteristics and modifiability of the present invention allows for versions of the present invention to be utilized for a variety of purposes relating to learning, skills training and other purposes relating to alveolar bone graft surgeries and other activities.

Many methods and processes may be applied to the creation of the elements of the simulator, and to the assembly thereof. For example, elements may be generated by 3D printing, molds and other processes. The following provides some examples or processes to create and assemble the elements of the present invention to form embodiments of the present invention. Other processes or variations of the processes described below are possible to create and assemble the simulator of the present invention, moreover, other elements than those described below can be formed and incorporated in the assembly of the present invention.

The simulator of the present invention incorporates three key elements, a cartridge, a face layer attachable to the cartridge and a cartridge base (or otherwise referenced as a simulator holder). These elements, their sub-elements and the assembly and function of each to form the simulator of the present invention are described below. The description is an example of an embodiment of the present invention and variations thereof are possible to form other embodiments of the present invention.

The elements of the oral cleft that can be corrected by an alveolar bone graft surgical procedure, can be configured into a cartridge. The cartridge may be removably connected to a face model to form a lower head component. The cartridge and lower head component are each attachable to the simulator base element (being a simulator holder) to form the fully assembled simulator. When connected to the simulator base element a surgical procedure may be performed upon the cartridge element, including when the cartridge element is combined with the face model. The simulator base element provides stability for the elements in the cartridge during an alveolar bone graft surgical procedure, or during any other surgical procedure or oral cleft training for which the simulator may be utilized.

An embodiment of the present invention incorporates a cartridge that includes the main components of the simulator and said cartridge is removably attachable to a base component (being a simulator holder). Said cartridge comprises an oral cavity that can be retracted during a simulated intra-oral procedure. Said oral cavity incorporates a bone component and soft tissue component of the maxilla with a gap in the alveolus. Said gap in the alveolus being either a unilateral cleft that involves a greater and lesser segment or a bilateral cleft that involves two lesser segments and a premaxilla in the midline. All references to “oral cleft” herein relate to either of the foregoing described gaps in the alveolus. Said bone component includes a nasal cavity and a palate. Maxillary teeth are attachable to the bone component.

Soft tissue is layered upon the bone component, which may be a maxilla bone component. Said soft tissue comprises synthetic periosteum, mucosa, gingiva. The skin of the face component further comprises soft tissue. The periosteum, mucosa and gingiva are positioned to be layered upon the bone component and in relation to each other in a manner that simulates the positioning of such soft tissue within a human head. The periosteum is attached to the bone component with a dissection plane between which allows for realistic separation during simulated surgery. A mucosal layer is layered upon the periosteum. Said mucosa layer can comprise multiple layers form so as to be separable using a dissection instrument. A gingival layer is also layered upon the periosteum. Said gingival layer tapers towards the maxillary teeth.

The oral cavity of the similar can include an upper buccal sulcus. It can further incorporate an oronasal fistula. The size of the cleft formed in the cartridge can be variable within embodiment of the cartridge incorporated in the simulator. Furthermore, the segments of the cleft can be of varying separation in both the coronal, sagittal and axial planes.

Said embodiment of the present invention further incorporates a face component having a mouth formed therein whereby the oral cavity is accessible when the face component is attached to the cartridge. The attachment between said face component and the cartridge may be a removable attachment or a fixed attachment.

When assembled the simulator comprises greater and lesser segment mucoperiosteal flaps that can be dissected off of the simulated bone. Furthermore, nasal side up turn mucoperiosteal flaps can be created, and palatal side down turn mucoperiosteal flaps can be created.

An embodiment of the present invention may be comprised so as to be used in any of the following manner:
i. The nasal side and palatal side flaps can be separated.
ii. The mucosa, gingiva and periosteum can be cut.
iii. The synthetic soft tissue can be sutured.
iv. A complete alveolar bone graft surgery can be completed that involves cutting, dissecting, separating layers and suturing soft tissue together.
v. A simulated tissue can be inserted into the cleft site to simulate the bone graft itself.

The materials utilized to form the elements of the present invention may vary. The hard tissue, such as the bone component, can be formed of any material with a firm quality.

The soft tissue elements can be formed of any material with a soft quality. In the embodiments of the present invention a variety of materials may be utilized. Some materials are expressly identified herein, however other materials having similar characteristics and properties may also be utilized to form elements of the present invention. As examples: elements that are simulations of soft tissue may be formed of any polymer, for example, such as silicone or urethane. The soft tissue elements may be formed of such material by casting (e.g., in a mold), 3D printing, or any other process. Examples of silicone that may be utilized to form simulated soft tissue elements includes DragonSkin™ (Smooth-On), EcoFlex™ (Smooth-On), platinum cured silicones. Simulated bone elements can be formed from materials such as polylactic acid, acrylonitrile butaediene styrene (ABS) or other polymers. The bone elements may be formed of such materials by casting using molds in ABS or other polymers, or by 3D printing by polylactic acid or other materials utilizable for 3D printing. The 3D printed simulated bone elements may be formed using a fused deposition type of 3D printer or a stereolithographic or light-based curing type of 3D printer. Descriptions of the use of particular materials set out herein are examples of materials used in some embodiments of the present invention, and other materials could be utilized in other embodiments of the present invention.

Embodiments of the present invention may incorporate some elements. The following are examples:
a. Any intervening interface may be incorporated between different layers and components between the soft tissue.
b. Any intervening interface may be incorporated between the hard and soft tissue components.
c. A material may be incorporated to fill the alveolar cleft.
d. The cartridge may incorporate either a unilateral alveolar cleft or a bilateral alveolar cleft that comprises a premaxilla, and two adjacent alveolar clefts on either side as well as two adjacent lesser segments on either side of the cleft.

As discussed herein, surgical tools utilized in an alveolar bone graft surgical procedure performed on a human may be used with the simulator. Embodiments of the present invention may further comprise a self retraction system that is removably attachable to the base of the simulator (the simulator holder). Such self retraction system uses may incorporate right angle retractors positionable so as to retract the oral cavity. Such self retraction system can be utilized for example to allow a single person to preform procedures upon the simulator that require retraction without the assistance of any other persons to hold the retractor during the procedure.

The present invention offers several benefits over know prior art. One such benefit is that the present invention is configured specifically to reflect the key physical elements of an oral cleft upon which an alveolar bone graft surgical procedure may be performed, including the interactions between such physical elements that simulate the interactions in human physiology.

Another benefit of the present invention over the known prior art is that the elements of the simulator (e.g., bone, tissue, and other elements) are formed of materials that have physical characteristics that are similar to those of the physical elements that they represent. For example, the bone elements are formed of materials that reflect the density, hardness and other characteristics of human facial bones, the tissue elements are formed of materials that have the flexibility, elasticity and other characteristics of human facial tissue, and other elements in the simulator are also formed of materials that have characteristics that have similarities to the physical human facial elements that they represent.

Yet another benefit of the present invention over the known prior art is that the configuration of the elements of the simulator reflect the anatomical complexities of a human face incorporating an oral cleft that is correctable by an alveolar bone graft.

Another benefit of the present invention over the known prior art is that it is configured through a layering of elements to comprise the simulator. Elements are formed individually and then configured in a manner whereby elements are attached to other elements in manner similar to the configuration and connections of a human oral cleft that is correctable by an alveolar bone graft surgical procedure. The effect of the layering is to create elements that are not only positioned in a similar manner to a human physiology, but that have similar connections and interactions in relation to each other in a similar manner to the elements of applicable human physiology. In particular, the ability to move certain elements within the simulator, and to move such elements in relation to other elements, during a surgical procedure performed upon the simulator will be similar to the experience of performing an alveolar bone graft surgical procedure upon a human. The layers of elements that must be addressed in an alveolar bone graft surgical procedure upon a human are reflected in the simulator. Additionally, the action of detaching elements from other elements within the simulator during a surgical procedure performed upon the simulator will be similar to the experience of performing an alveolar bone graft surgical procedure upon a human.

A still further benefit of the present invention over the prior art is that it allows for use of the simulator to provide not only a simulation of the manipulation of elements in an alveolar bone graft surgical procedure, but also allows for the user to experience a similar feel of the elements in involved in such a surgical procedure. This facilitates learning that better reflects the realities of performing an alveolar bone graft surgical procedure on a human, which can reduce the likelihood of errors by a surgeon who has trained their surgical skills by using the simulator. The formation of the elements of the simulator further promotes other forms of learning relating to the oral cleft condition that necessitates an alveolar bone graft, such as visual identification of elements and positioning of elements, interactions of elements, and other types of learning relating thereto.

### Simulator Components and Assembly

### Cartridge Components

An embodiment of the present invention can be formed in accordance with the following process, to comprise of the elements and components described below.

### Component 1: Maxilla

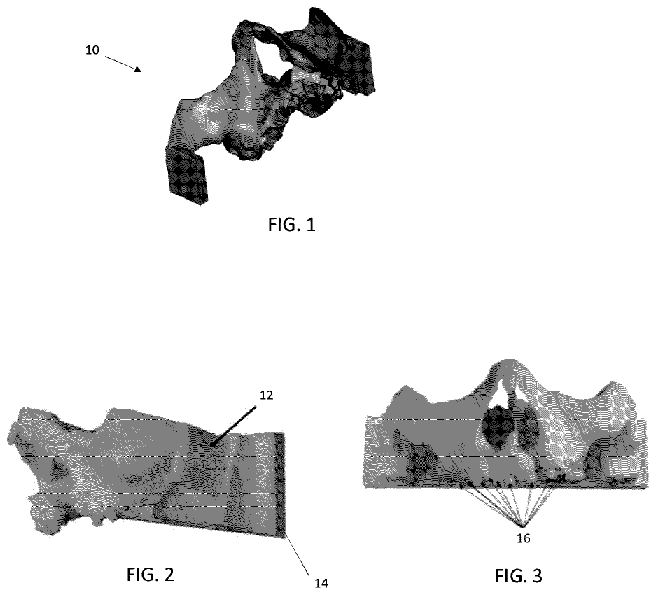

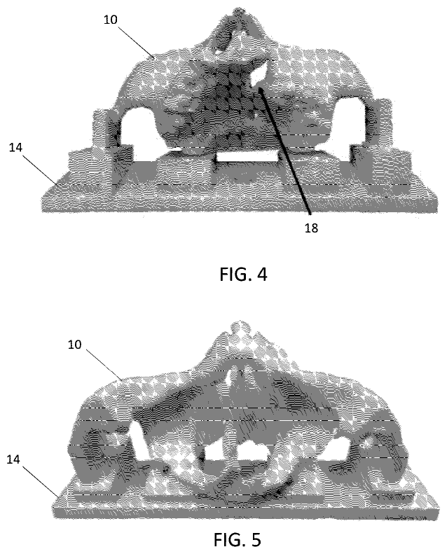

The maxilla component 10, as shown in FIG. 1 is a bone component of the cartridge of the present invention. In embodiments of the present invention the maxilla component can be 3D printed with Elegoo Mars3 Pro using white water-washable resin (2.5 s exposure 35 s bottom layer exposure 0.05 mm layer height). The maxilla component may also be formed in other manners from materials that simulate the feel of a human maxilla bone. As shown in FIG. 2, the maxilla component can incorporate a maxilla connector element 12, whereby the maxilla is removably connectable to a construction base element 14. Such connection may be via the connector element being inserted into a groove or indentation in the construction base element, or the construction base element may incorporate an extrusion extending therefrom which can be aligned with the connector element and the extrusion and connector element may be connected by an adhesive or another attachment. FIGS. 4-5 further show the maxilla component 10 attached to a construction base element 14. The construction base element may be utilized to stabilize the maxilla element during the process whereby the cartridge is formed.

As shown in FIG. 3, the maxilla component may incorporate extrusions that are formed as teeth connections 16. Whereby teeth are attachable to the maxilla component. As shown in FIG. 4 the maxilla component is formed to incorporate a palate defection 18 that forms a portion of the oral cleft incorporated in the cartridge, and is the base portion of such oral cleft.

### Component 2: Mesh

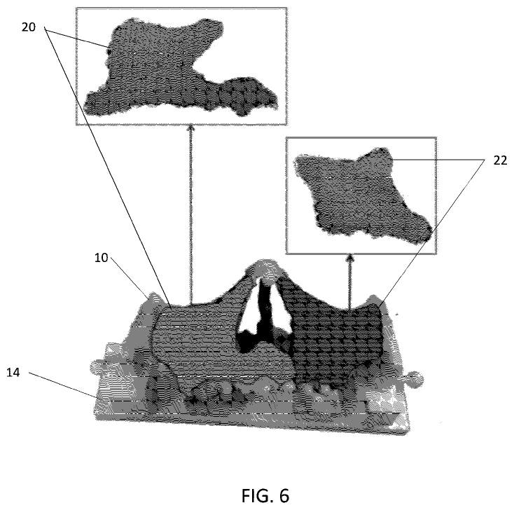

Mesh components 20 and 22 may be attached to the maxilla component. As shown in FIG. 6 the mesh components may be different shapes to accommodate a cleft side mesh element 22 and a non-cleft side mesh element. The cleft side mesh element will be positioned on the side of the maxilla where the oral cleft is to be formed, and the non-cleft side mesh component will be positioned on the other side of the maxilla. The mesh components may be form of power mesh. Other materials may also be utilized for the mesh components. The shape of each mesh components may be traced from the maxilla component, such as tracings from along the nasal cavity and gingiva formed in the maxilla.

### Component 3: Face

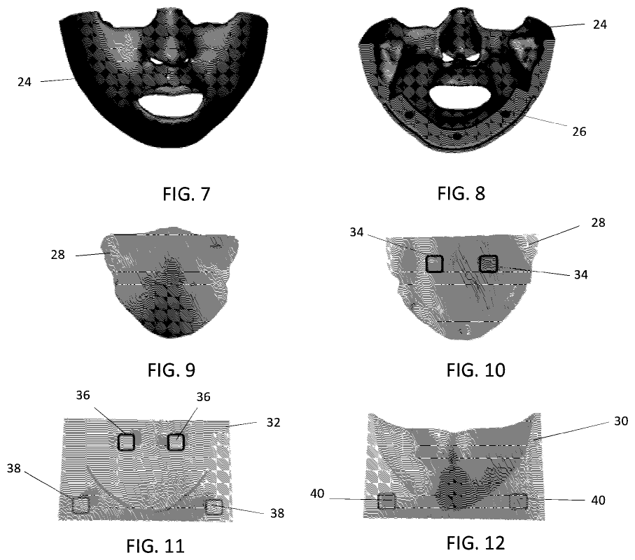

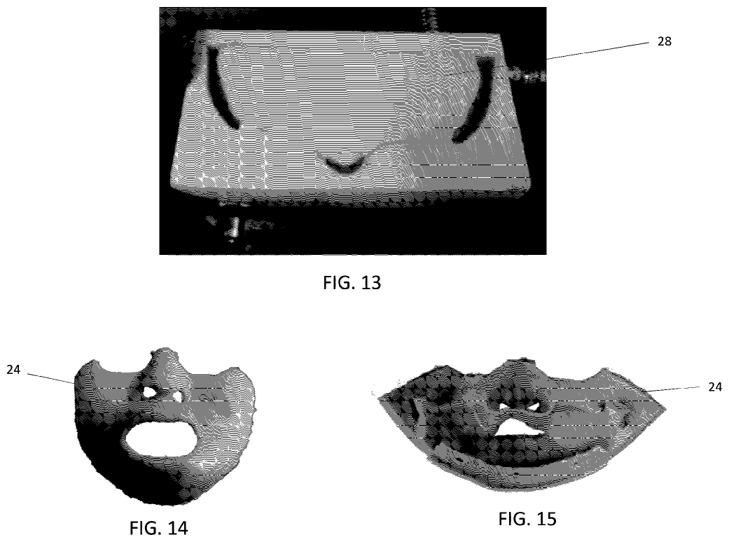

The face component 24 as shown in FIG. 7 is formed to simulate human facial skin. As shown in FIG. 8, the rear side of the face component may further comprise one or more facial connectors 26 whereby the face component is attachable to the cartridge.

The face component may be created through the use of a mold. The mold may be a printed mold. Such a mold may consist of multiple subcomponents. For example, as shown in FIGS. 9-12, a mold may consist of a back mold component 28, a front mold component 30, and mold base component 32. Each subcomponent may be printed with Ultimaker 3 using PLA (10% infill; 0.15 mm layer height; supports for subcomponent 4.2 only). Other methods for creating the mold and any of its components and other materials may also be used.

A mold used to form the face component is assembled by fitting mold base upper extrusions 36 formed on the mold base (as shown in FIG. 11) into corresponding back mold indentations 34 formed on the back mold component (as shown in FIG. 10); and fitting mold base lower extrusions 38 formed in the mold base (as shown in FIG. 11) into the corresponding front mold indentations 40 formed in the front mold component (as shown in FIG. 12).

The mold can be held together with clamps, such as c-clamps, or another mechanism that holds the assembled pieces in a static position while silicone is poured into the mold. The mold will form the face components after the material used to form the face component has cured (for example, 2-4 hours may be required for silicone to cure). In an embodiment of the present invention Ecoflex-20 silicone (dark flesh color; 150 mL) may be utilized to form a face component using a printed mold.

### Component 4: Teeth

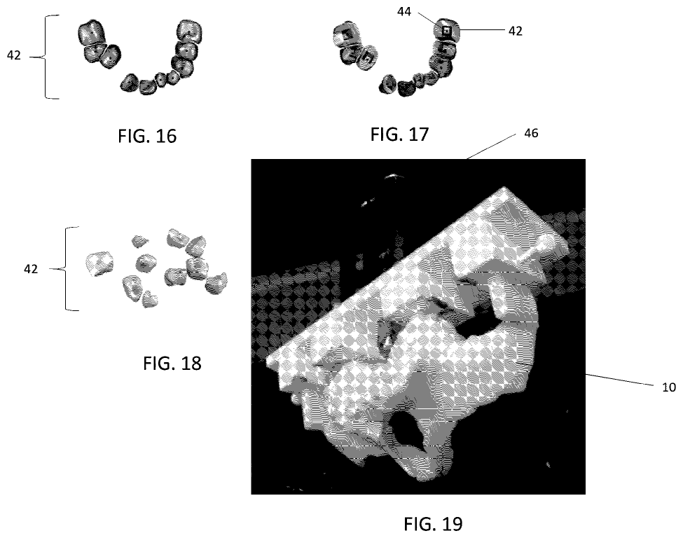

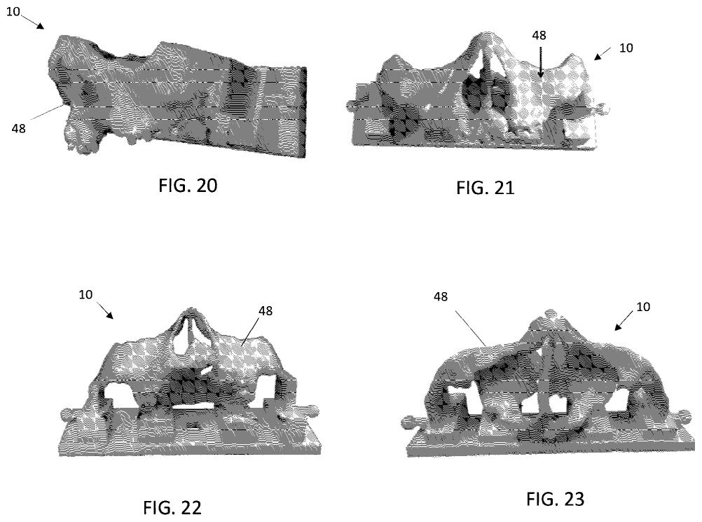

One or more teeth components 42 may be incorporated in the present invention. For example, an embodiment of the present invention may incorporate ten teeth components as shown in FIG. 16. Teeth may be 3D printed in batch with Elegoo Mars 3 Pro using white water-washable resin (2.5 s exposure; 35 s bottom layer exposure; 0.05 mm layer height). Other materials and methods may be applied to form teeth components. As shown in FIG. 17, each teeth component may be formed to incorporate an teeth indentation 44 therein which is configured to attach to a teeth connection 16.

### Cartridge Fabrication Process

Several steps are involved in the fabrication of the cartridge. Below is an example of the steps performed in an embodiment of the present invention. Alternate steps and fabrication processes may be applied in other embodiments of the invention.

### Step 1: Coating Maxilla Component

One or more layers of a coating 48 may be applied to the outer surface of the maxilla component 10. For example, a shellac coating may be applied to the outer surface of the maxilla component. Other materials can be used for the coating. The coating mediates adhesion between the maxilla component and materials, such as silicone, utilized to form other layers incorporated in the cartridge.

In an embodiment of the present invention, as shown in FIG. 19, the maxilla component 10 may be mounted on a on a rotisserie 46 and the rotisserie may function to rotating and thereby to rotate the maxilla component. A brush can be utilized to apply a coating of shellac on all exposed surfaces on the maxilla component. After the shellac coating dries (e.g., approximately 30 mins) the procedure can be repeated, to apply at more than one layer (for example, least 4 layers of shellac coating).

### Step 2: Painting the First Periosteal Layer

A first periosteal layer 50 may be formed upon the maxilla component, and thereby be incorporated as a layer of the cartridge. For example, a silicone can be utilized to create the first periosteal layer. Other materials can be used for the first periosteal layer.

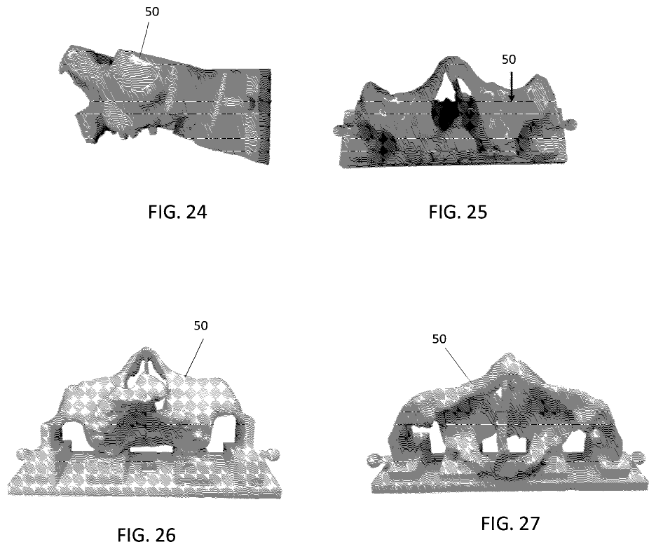

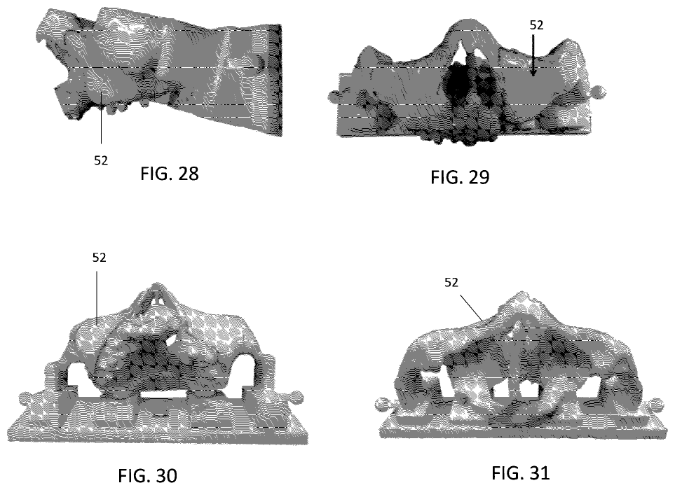

In an embodiment of the present invention, a first periosteal layer may be formed by utilizing a brush to paint a thin layer of Dragonskin-fx pro silicone (white color; 3 mL) on the maxillary areas of the maxilla component (as shown in FIGS. 24-27). The silicone must cure (in approximately 30 mins) before the next step commences.

### Step 3: Applying Mesh and Painting Second Periosteal Layer

A second periosteal layer 52 may be formed upon the maxilla component, and thereby be incorporated as a layer of the cartridge. For example, a combination of one or more mesh elements layered upon the first periosteal layer and silicone layer applied to such mesh elements, can be utilized to create the second periosteal layer. Other materials can be used for the first second layer.

In an embodiment of the present invention, the second periosteal layer may be formed by matching the edges of the mesh elements with corresponding edges of the nasal cavity and gingiva to identify the where the second periosteal layer should be positioned in relation to the maxilla component. A brush can be used to paint a layer of Dragonskin-fx pro silicone (white color; 3 mL) over the previous periosteal layer. The silicone must cure (in approximately 30 mins) before the next step commences, and care should be taken to ensure that the mesh elements are tacked down throughout the curing process.

Together the first periosteal layer and the second periosteal layer form the periosteum within the cartridge.

### Step 4: Applying the First Mucosa Layer

A first mucosa layer 54 may be formed as a layer upon the maxilla component, and thereby be incorporated as a layer of the cartridge. For example, a silicone can be utilized to create the first mucosa layer. Other materials can be used for the first mucosa layer.

In an embodiment of the present invention, the first mucosa layer may be formed by using a syringe to dispense Dragonskin-fxpro silicone (light red color; 7 mL) over the maxilla component. The maxilla component may be attached to a rotisserie that functions to rotate, and thereby rotates the maxilla component. The spinning motion applied by the rotisserie will distribute the silicone evenly, resulting in a thin layer being formed. The silicone must cure (in approximately 30 mins) before the next step commences.

### Step 5: Applying the Fat Layers

One or more fat layers 56 may be formed as a layer upon the maxilla component, and thereby be incorporated as a layer of the cartridge. For example, a silicone can be utilized to create the one or more fat layers. Other materials can be used for the one or more fat layers.

In an embodiment of the present invention, the first fat layers may be formed by positioning the maxilla component such that the bottom of the maxilla component is facing upwards. A brush may be used to paint two layers of Dragonskin-fx pro silicone (dark red color; 3 mL) over the maxillary areas of the previous mucosa layer. The silicone must cure (in approximately 30 mins) before applying another fat layer, and, once all of the fat layers are added, before the next step commences.

The exact positioning, thickness and characteristics of each layer formed in the cartridge will be in accordance with the requirements of the corresponding physical element in a human that is being formed.

### Step 6: Attaching the Face Component to the Cartridge

Once the layers discussed herein the form the cartridge are layered upon the maxilla, the cartridge can be attached to the face component. The cartridge can be attached through means of an adhesive, or by other means whereby the cartridge and face component are firmly attached such that the attachment will not slip or become lose. The attachment may be a fixed attachment or a removable attachment. Various attachment means may be utilized in embodiment of the present invention.

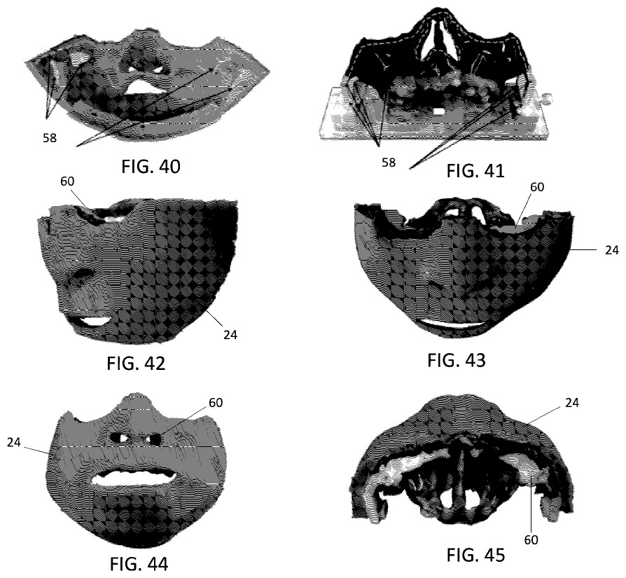

In an embodiment of the present invention, the face component may be attached to the cartridge after the maxilla component is dismounted from the rotisserie. Loctite SF7701 primer and Loctite 4851 adhesive, may be utilized to glue the face component to the maxilla. Such adhesive may be applied to areas of the face component, and to areas of the cartridge (for example such as along the dotted lines 58 depicted in FIGS. 40 and 41).

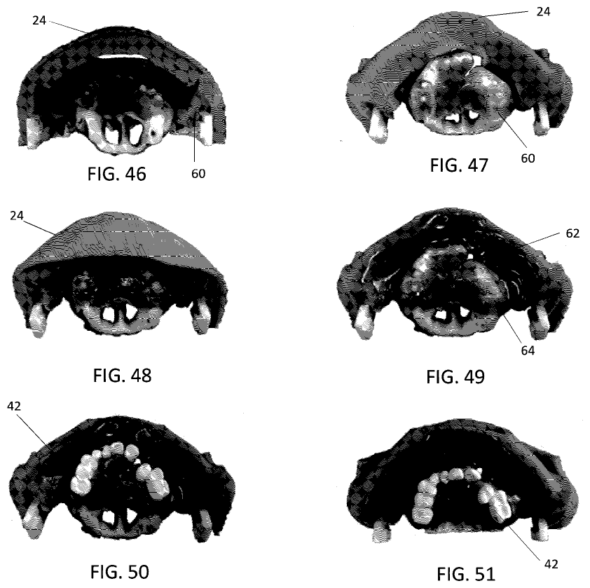

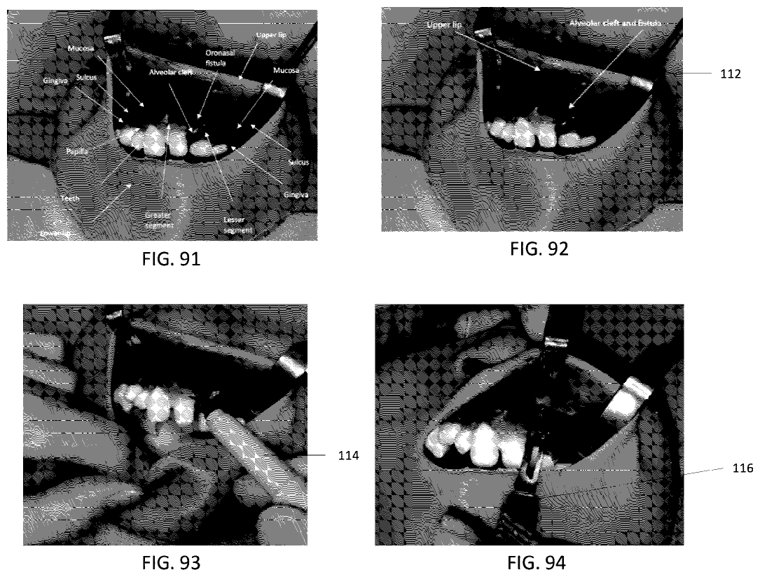

Examples of the face component 24 attached to the cartridge 60 are shown in FIGS. 42-47. When the face component is attached to the cartridge the result incorporates all of the following physiological elements, as shown in FIG. 91: Mucosa, Sulcus, Gingiva, Papilla, Teeth, Lower lip, Greater segment, Less Segment, Upper lip, Oronasal fistula, and Alveolar cleft.

### Step 7: Applying Two More Layers of Mucosa

One or more additional mucosa layers 62 may be formed as a layer upon the cartridge 60 after the face component is attached to the cartridge. For example, a silicone can be utilized to create the one or more additional mucosa layers. The face component 24 must be positioned to expose the palate section 64 of the cartridge (as shown in FIG. 49). Other materials can be used for the one or more additional mucosa layers.

In an embodiment of the present invention, the additional mucosa layers may be formed by remounting the maxilla to the rotisserie and starting the rotisserie rotating. The face component can be flipped over to expose the palate section of the cartridge. A syringe can be used to dispense two layers of Dragonskin-fxpro silicone (light red color; 7 mL) over the maxilla component. The silicone must cure (in approximately 30 mins) before applying another mucosa layer, and, once all of the mucosa layers are added, before the next step commences.

### Step 8: Attaching the Teeth Component to the Model

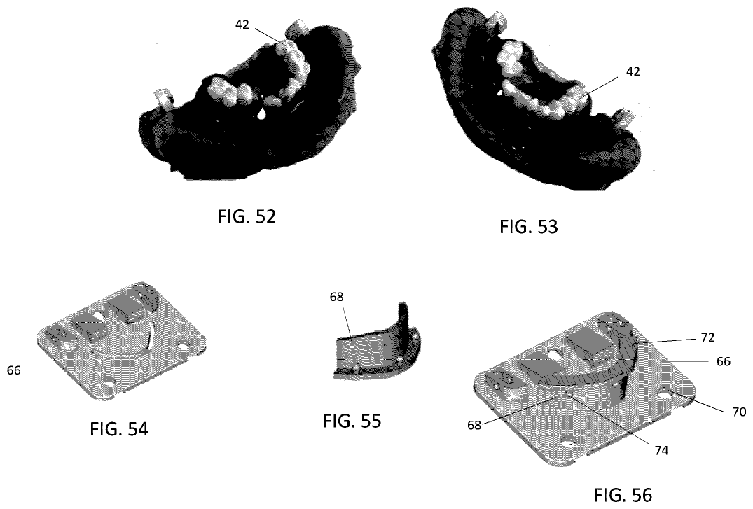

The teeth components 42 can be attached to the cartridge (as shown in FIGS. 51-53). Such attachment can occur by aligning a teeth connection formed in the cartridge with a teeth indentation formed in a teeth component. The areas the teeth can be cleaned using a knife as needed (e.g., to remove silicone or other materials). Teeth components can be attached to the cartridge using various means and materials, including via an attachment sustained by force pressures between the teeth connection and the teeth indentation, or via an adhesive, or via other means or materials.

In an embodiment of the present invention, teeth components may be attached to the cartridge using Loctite SF7701 primer and Loctite 4851 adhesive. Such adhesives can be applied to the teeth indentations or to the corresponding teeth connections.

### Simulator Holder Components

### Component 5: Base Component (the Surgical Simulator Holder)

As shown in FIGS. 54-56, the base component (which is the surgical simulator holder) is formed of a base element 66 having a ledge support 68 attached thereto. The attachment may be by various means, including pins, adhesives or other attachment means. Said ledge support being formed to incorporate a base ledge 72, and one or more base pins 74. Embodiments of the present invention may further incorporate one or more base clamp holes 70. The base component may be formed of various materials and by various methods. An embodiment of the present invention could also incorporate a base component wherein the ledge support is formed in the base element as a single element.

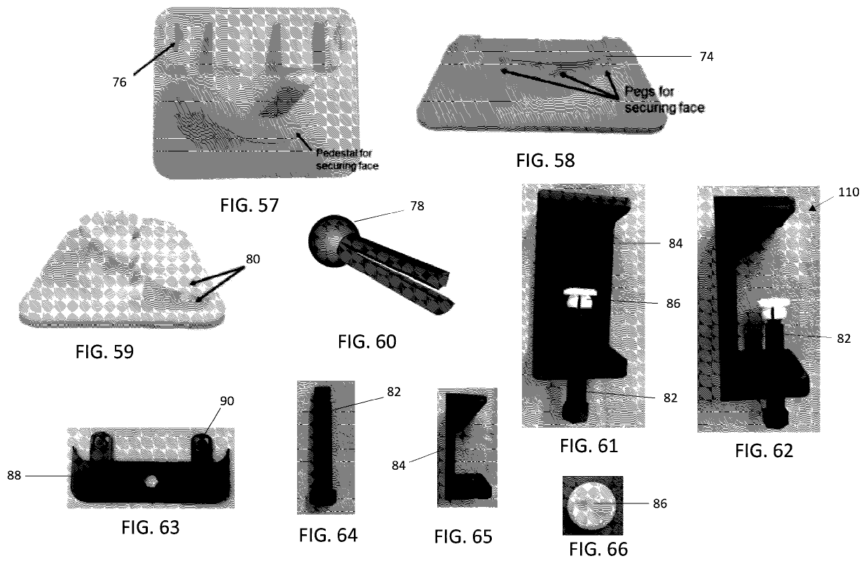

The base component further incorporates one or more base connectors 76 whereby the cartridge having the face component attached thereto, can be attached to the base component. For example, as shown in FIGS. 57-59, one or more base connectors formed of base extrusions extending from the base element having slots or other indentations formed therein.

In an embodiment of the present invention, the base component and the elements that form the base component may be printed with Ultimaker 3 using PLA (settings: 10% infill; 0.15 mm layer height, no supports). The printed base element and ledge support subcomponents may glued together, for example, such as by using Loctite SF7701 primer and Loctite 4851 adhesive.

### Component 6: Securing Pins

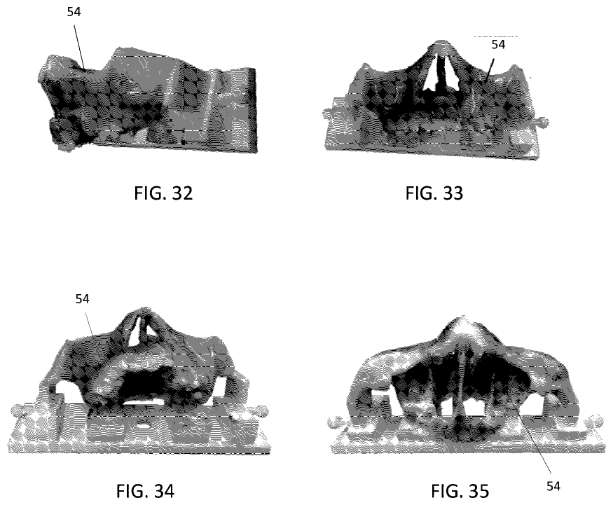

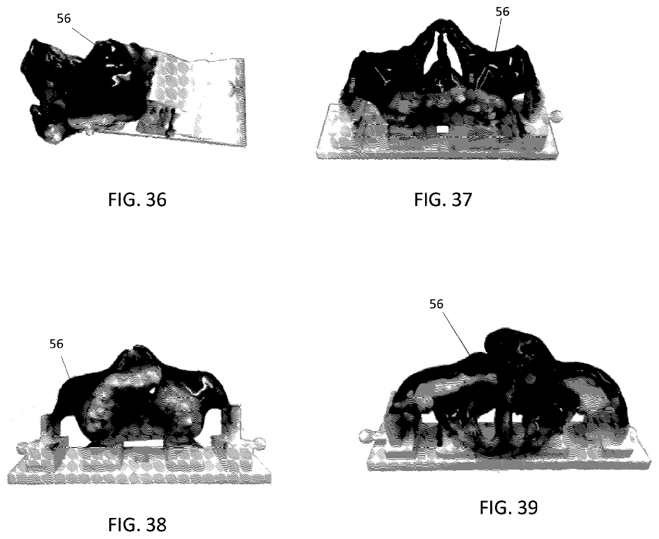

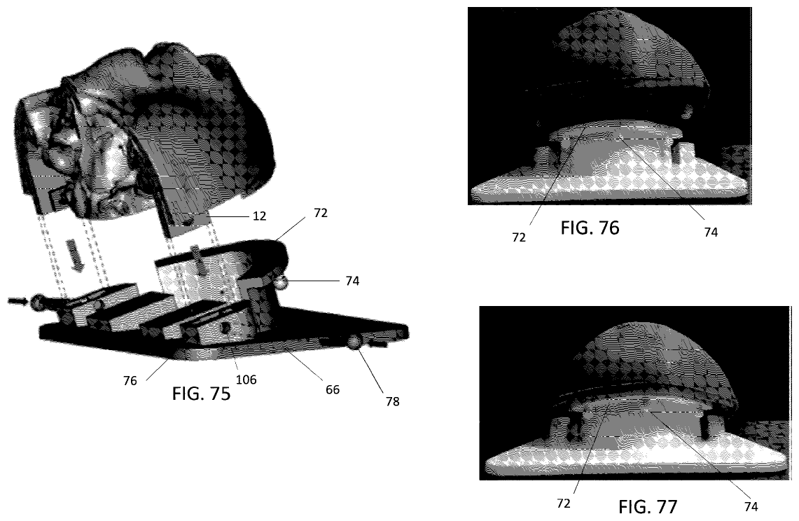

As shown in FIG. 75, one or more securing pins 78 can be used to attach the cartridge to the base component, such as by inserting a securing pin into holes 80 formed in a base connector (as shown in FIG. 59). One embodiment of the securing pins consists of two identical subcomponents (model in FIG. 31), printed with Ultimaker 3 using PLA (10% infill; 0.15 mm layer height; supports) (photos in FIG. 32).

When a maxilla connector element 12 on the maxilla component is inserted into a corresponding base connector 76 on the base component, if said maxilla connector element and the corresponding base connector have holes formed therein which align when the maxilla connector element is inserted into the corresponding base connector, a securing pin can be are inserted into such holes to stabilize the attachment (as shown in FIG. 75.

### Component 7: Clamp

A clamp component can be utilized to hold the base component in a particular position upon a table or other surface. The use of the clamp component is optional. The purpose of the clamp component is to increase the base adhesion to slippery surfaces, particularly when the surgical simulator is used with external retraction.

In an embodiment of the present invention, the clamp component can consist of four elements, a clamp body 84 (formed to incorporate a flat side having a 45 degree or virtually 45-degree bend therein on each end thereof), a clamp screw plate 86, and a clamp base connector 88. The clamp component can be printed with Ultimaker 3 using PLA (20% infill; 0.15 mm layer height; supports on subcomponent 7.1 only). The clamp component can be assembled, as shown in FIGS. 61 and 62, by screwing the clamp screw 82, into corresponding threads formed on the clamp body 84. and then pressure fitting the clamp screw plate onto the tip of the clamp screw. The clamp body can be mated with the clamp base connector by pressing the clamp body into a correspondingly shaped cavity formed in the clamp base connector. The clamp attaches to the base element of the simulator holder by inserting the clamp base connector pins 90 in the clamp base connector into corresponding clamp holes at the bottom of the base element.

### Component 8: Retraction Assistance Device

A retraction assistance device can be utilized to retract portions of the face component as required for the oral cavity to be visible for the alveolar bone graft surgical procedure and to hold the retracted position. Use of the retraction assistance device can assist a single user to perform a surgical procedure on the simulator without needing a second person in attendance to hold a retractor. The retraction assistance device can be formed in various configurations, and from various materials.

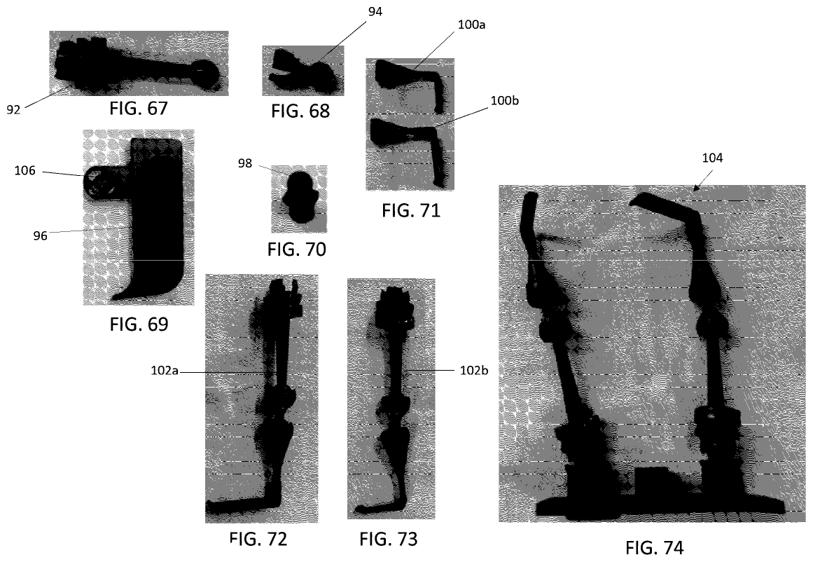

In an embodiment of the present invention the retraction assistance device 104 (as shown in FIG. 74) can be 3D printed and is formed from components that include, an arm base component 96 (as shown in FIG. 69) and the following components for each of the two assembled retraction arms 102a and 102b (shown in FIGS. 72 and 73): a lower arm component 92 (as shown in FIG. 67), an arm ball mount connector component 94 (as shown in FIG. 68), a lower arm ball mount connector 98 (as shown in FIG. 70), and an upper arm component 100a or 100b as shown in FIG. 71.

The retraction assistance device, and its components can be 3D printed with Ultimaker 3 using PLA (20% infill; 0.15 mm layer height; supports on all components). Each assembled retraction arm can be assembled by pressure fitting: a lower arm component over a lower arm ball mount connector; an arm ball mount connector component over a lower arm component; and an upper arm component over an arm ball mount connector component at the ball joints. Each assembled retraction arm can be attached to the arm base component by screwing the lower arm ball mount connector of each arm into corresponding threads on the arm base component, to form the retraction assistance device.

The retraction assistance device is removably attachable to the base element by inserting the buckle 106 formed in the arm base component into a corresponding slot at the top of the base element. The ends of the upper arm components on each arm can be fitted with different retractors appropriate to the functions occurring during the alveolar bone graft surgical procedure performed on the simulator.

The use of a retraction assistance device when utilizing the simulator is optional. However, use of the retraction assistance device enables self-sufficient performance of a surgical procedure upon the simulator, and thus alleviates the need for stronger base adhesion.

### Simulator Features

### Modular Design

The surgical simulator is assembled by attaching the cartridge to the base component. The base component is reusable. The base component assists with immobilizing and stabilizing the cartridge while the surgeon operates, as well as positioning the cartridge in an authentic orientation. The cartridge can be attached to the base component with the face component attached to the cartridge or without the face component being attached to the cartridge.

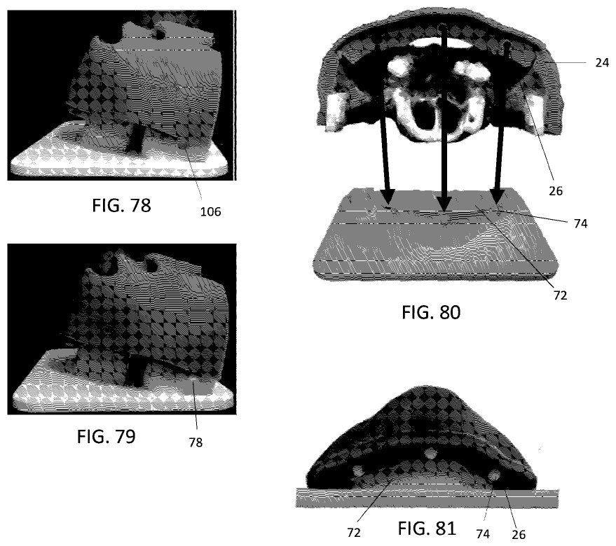

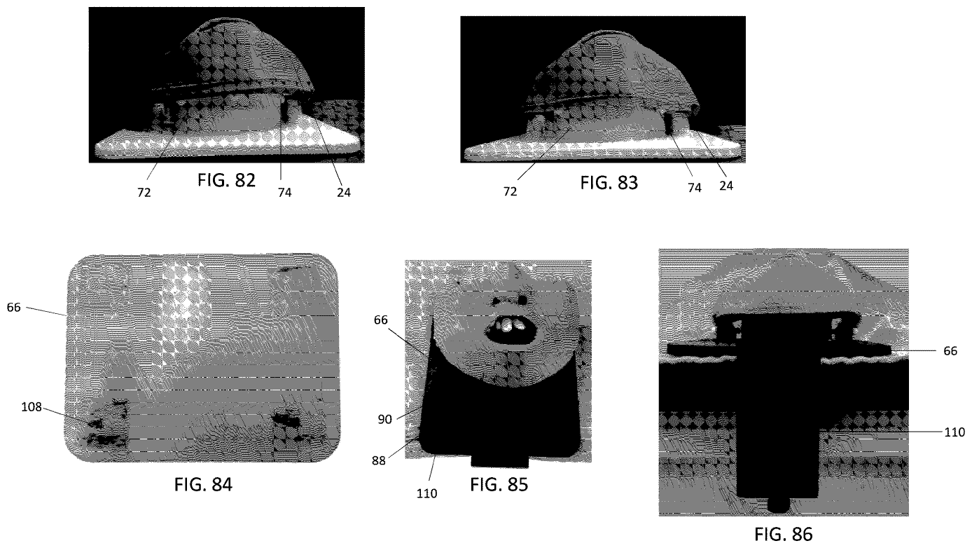

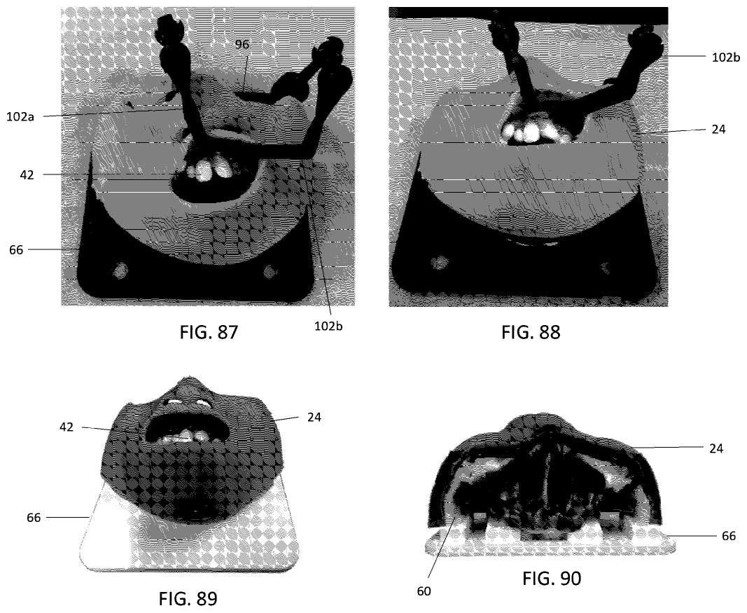

As shown in FIGS. 75-79, to attach the cartridge to the base component, the cartridge is positioned above the base component and the cartridge is lowered base component such that the maxilla connector elements 12 (formed on either side of the maxilla) are inserted into corresponding base connectors 76 formed in the base until there is alignment between holes formed on the maxilla connector elements and base connector holes 106 (formed in the corresponding base connectors). Securing pins 78 can be inserted through the aligned holes to stabilize the connection between the base component and the cartridge.

The cartridge does not include any solid mandible components. In order to limit lower jaw movement during a surgical procedure performed on the simulator, the cartridge has a second securing mechanism binding it to the base component.

As shown in FIGS. 80-83, the face component can be pulled over the ledge 72 on the base component. The one or more facial connectors 26 formed on the rear side of the face component can be positioned such that each facial connector corresponds with one of the one or more base pins 74, and the one of the one or more base pins fits within a facial connector (which is formed as a hole in the rear side of the face component has is configured to form a pressure connection when the base pin is fit within a facial connector.

As shown in FIG. 75, the cartridge can be lowered towards the base component along the dotted lines extending from the base connectors in the direction indicated by the arrows shown to be aligned with such dotted lines. Once the holes in the maxilla and the base connector holes 106 align, the arms of the securing pins 78 can be pinched and the securing pin can then be slid through the aligned holes along the dotted lines shown as extending from base connector hole 106 in the direction of the arrows shown near the securing pin. Gentle force can be applied during the lowering of the cartridge towards the base component until the holes in the maxilla extensions align with the base connector holes.

### Base Component Adhesion

An adhesive can be attached to the base component whereby the base component can be removably attached to a surface upon which it is placed. Such adhesive can cause the base component to sufficiently adhere to such supporting surface such that the base component resists movement caused by external retraction or other forces exerted upon the simulator during use thereof, including during any surgical procedure.

In one embodiment of the present invention, such adhesion can be created by attaching one or more adhesive pieces 108 to the bottom side of the base component. For example, four scotch re-stickable mounting squares can be attached to the bottom side of the base component such that one is positioned at each corner of the base component. The adhesives can be used to removably adhere the base component to the supporting surface upon which it is places by pressing the base component firmly against its such supporting surface.

On more slippery supporting surfaces, basic adhesion may be insufficient to resist the exertion of strong forces upon the simulator, such as occur during external retraction. In such instance the cartridge may flip over. In such an instance the base component can be secured to a supporting surface that has a protruding edge (i.e., table or desk) using the clamp component 110, as shown in FIGS. 85 and 86. The clamp base connector 88 can be attached to the base component 66 when the clamp is utilized to secure the simulator.

### Self-Sufficient Retraction Option (Permits Use of Simulator by a Single Person)

For self-sufficient performance of a surgical procedure upon the simulator, the user may use the retraction assistance device. Each of the assembled retraction arms 102a and 102b of the retraction assistance device can be fitted with retraction tools, and positioned to retract portions of the face component 24 to permit access to and sight of elements of the cartridge, such the teeth components 42 and other elements of the cartridge. Such use of the retraction assistance device allows a single user to complete a surgical procedure upon the simulation, such as an alveolar bone graft. In embodiments of the present invention, the assembled retraction arms each have three adjustable joints, providing a wide positioning envelop. In some embodiments of the present invention the lowest joint of the assembled retraction arms may be lockable, so as to reinforce the retractor against reactionary flexure forces exerted by the face component when it is retracted.

Furthermore, due to the fact that the retraction assistance device attaches to the base component, there are no forces exerted upon the base component resulting from any external retraction. Thus, use of the retraction assistance device can alleviate the need to utilize any adhesive upon the bottom side of the base component. Use of the retraction assistance device with the simulator allows for surgical procedures to be performed on the simulator when the simulator is positioned upon a supporting surface without requiring use of a clamp, and therefore there is no need for such supporting surface to incorporate a protruding edge suitable for clamping.

The retraction assistance device and clamp component can both be used simultaneously to stabilize the simulator to create enhanced experience of significant stability during a surgical procedure performed upon the simulator.

### Method

The simulator can be utilized for the purpose of training regarding surgical procedures relating to oral cleft conditions correctable by an alveolar bone graft surgical procedure, and other training relating to such condition and surgical procedure. For example, the present invention can be used to perform an alveolar bone graft surgical procedure from start to finish using real surgical instruments. The following procedural steps can be performed on the simulator when it is fully assembled.
Incise through synthetic mucosa using a blade.
Incise around the alveolar fistula to create up-turned nasal floor flaps.
Incise along the greater segment mucosa and gingiva using a surgical blade.
Incise along the lesser segment mucosa and gingiva to create an advancement flap to cover the anterior wall of the cleft.
Elevation of the mucoperiosteum off of the underlying bone using an elevator.
Incision through the periosteum to allow the mucoperiosteal flap to advance into the cleft.
Dissection of the mucoperiosteum off of the lesser and greater segment bony margins towards the posterior notch of the alveolar cleft.
Suturing of up-turned nasal floor flaps.
Suturing of down-turned palatal floor flaps.
Placement of a simulated graft material into the alveolar cleft site
Advancement of the lesser segment mucoperiosteal flap anteriorly and suturing the flap to create the anterior wall of the cleft site.

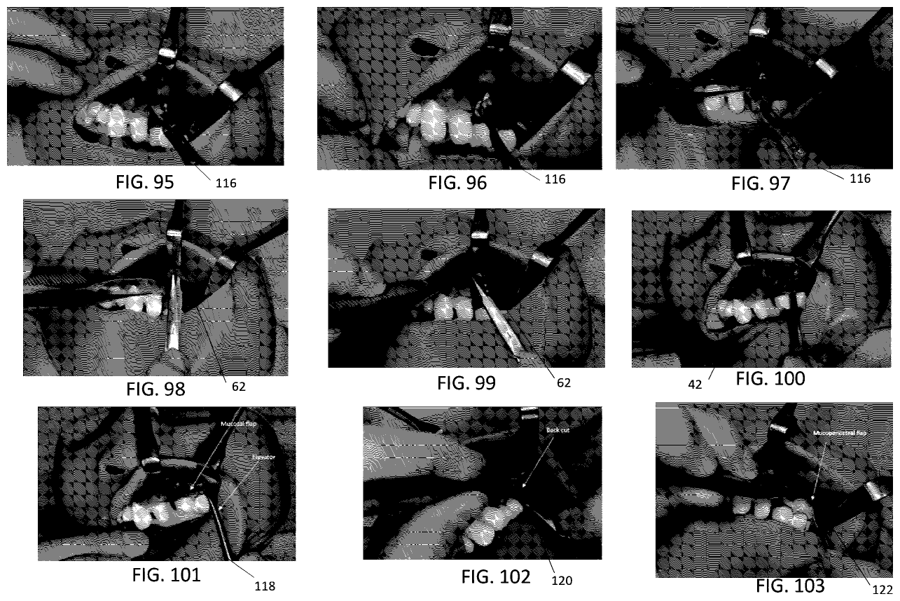

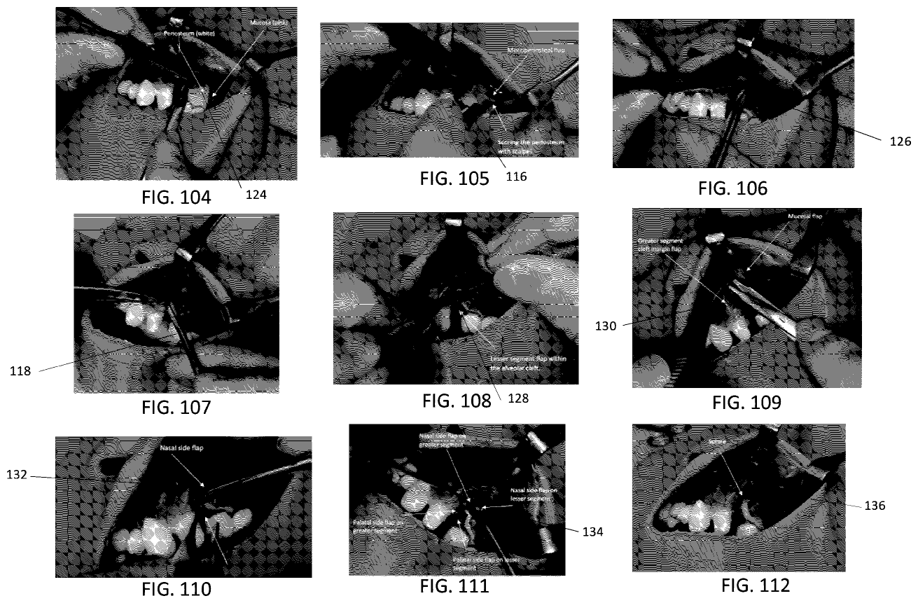

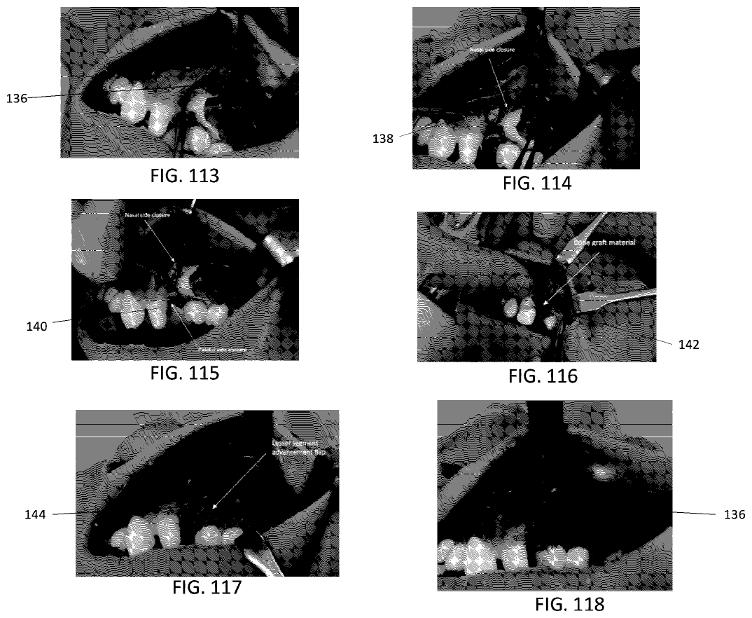

FIGS. 92-118 depict the use of the simulator to perform an alveolar bone graft surgical procedure, including the following steps:
1. Use of a retractor 112 to expose alveolar bone graft site in preparation for surgery (as shown in FIG. 92).
2. Mark with a marker 114 the planned incision around the cleft and oronasal fistula (as shown in FIG. 93).
3. Make an incision around the oronasal fistula using a scalpel 116 (as shown in FIG. 94).
4. Make incision along the greater segment cleft margin using a scalpel 116 (as shown in FIG. 95).
5. Make incision along the lesser segment cleft margin using a scalpel 116 (as shown in FIG. 96).
6. Make incision along the gingival margin of the greater segment cleft margin using a scalpel 116 (as shown in FIG. 97)
7. Perform dissection of the mucosa 62 from underlying deeper tissue along the anterior/superior aspect of the oronasal fistula (as shown in FIG. 98).
8. Perform continued dissection of the mucosa 62 from deeper tissue along the oronasal fistula using scissors (as shown in FIG. 99).
9. Perform separation of the gingival papilla from the teeth component 42 to elevate the lesser segment mucosal flap using a scalpel (as shown in FIG. 100).
10. Perform elevation of the mucoperiosteal flap using an elevator 118 (as shown in FIG. 101).
11. Make a backcut 120 in mucosa posteriorly along the lesser segment. Backcut is through superiosteal plan (as shown in FIG. 102).
12. Perform further elevation of the mucoperiosteal flap 122 using an elevator and forceps (as shown in FIG. 103).
13. Perform incising through vertical component of the periosteum 124 at the lesser segment cleft margin using scissors (as shown in FIG. 104).
14. Score the periosteum using the scalpel 116 along the bone-persioteal interface of the lesser segment mucoperiosteal flap (as shown in FIG. 105).
15. Join the incision around the superior component of the oronasal fistula 126 with the lesser segment cleft margin incision (as shown in FIG. 106).
16. Perform elevation of the greater segment mucoperiosteal flap at the cleft margin using an elevator 118 (as shown in FIG. 107).
17. Perform elevation of lesser segment flap 128 within the cleft site using an elevator (as shown in FIG. 108).
18. Perform further elevation and connection of mucosal flap between alveolar cleft site and anterior-superior component of the oronasal fistula using scissors along the greater segment 130 (as shown in FIG. 109).
19. Perform creation of nasal side flap 132 and palatal side flaps using scissors (as shown in FIG. 110).
20. Perform elevation of the nasal side flap on the lesser segment side 134 (as shown in FIG. 111).
21. Place a suture 136 at junction of anterior/superior component of oronasal fistula and nasal side flaps (as shown in FIG. 112).
22. Perform closure of the nasal side up-turned flaps with sutures 136 (as shown in FIG. 113.
23. Perform completion nasal side closure 138 of the oronasal fistula back to the cleft apex (as shown in FIG. 114).
24. Perform closure of the palatal side 140 down turned flaps and closure of the nasal side up turned flaps (as shown in FIG. 115).
25. Perform insertion of “bone graft” material 142 into the alveolar cleft (as shown in FIG. 116).
26. Perform advancement of the lesser segment mucoperiosteal flap 144 towards the greater segment flap (as shown in FIG. 117).
27. Complete closure of the cleft site using sutures 136 (as shown in FIG. 118) It will be appreciated by those skilled in the art that other variations of the embodiments described herein may also be practiced without departing from the scope of the invention. Other modifications are therefore possible. For example, the simulator can be utilized for the performance of other surgical procedures beside alveolar bone grafts, that can be performed upon an oral.

1. An alveolar bone graft surgery simulator comprising: a cartridge configured to incorporate an oral cavity having a cleft of the alveolus formed therein; a model that resembles a human face to which the cartridge is removably attachable, and a base configured to removably attach to the model and to the cartridge.

2. The alveolar bone graft surgery simulator of claim 1, wherein the cartridge incorporates bone components and soft tissue components configured to form a maxilla having a gap in the alveolus.

3. The alveolar bone graft surgery simulator of claim 1, wherein the connection between the model and the base is operable to: hold the model at an orientation that is the orientation of a face during an alveolar bone graft surgical procedure; and to stabilize the model during a simulation alveolar bone graft surgery performed upon the alveolar bone graft surgery simulator.

4. The alveolar bone graft surgery simulator of claim 1, wherein the model is devoid of solid mandible components.

5. The alveolar bone graft surgery simulator of claim 1, wherein a retraction assistance device is removably attached to the base, and functions to provide retraction of elements of the cartridge and model during use of the alveolar bone graft surgery simulator.

6. The alveolar bone graft surgery simulator of claim 1, where a clamp is removably attached to the base and said clamp is operable to hold the alveolar bone graft simulator in a stable and stationary position.

7. A method of forming an alveolar bone graft surgery simulator consisting of:
a. forming a cartridge by layering simulated physiological tissues upon a simulated maxilla bone to form a cleft of the alveolus, said maxilla bone having a base connector component formed therein;
b. forming a face component that simulates human facial skin, and incorporates face connector elements in a rear side of said face component;
c. attaching the face component to the cartridge to produce a simulated human head or portion thereof having a cleft of the alveolus formed therein; and
d. attaching the combined cartridge and face component to a base through connection of the face connector elements to corresponding base pins, connection of the base connector in the maxilla bone to corresponding slots in the base.

8. A method of performing alveolar bone graft surgery upon an alveolar bone graft surgery simulator consisting of:
a. assembling the alveolar bone graft surgery simulator by connecting a cartridge configured to incorporate an oral cavity having a cleft of the alveolus formed therein to a base configured to removably attach to the model; and
b. performing an alveolar bone graft surgical procedure upon the alveolar bone graft surgery simulator.
